(19) United States
(12) Patent Application Publication
(10) Pub. No.: US 2009/0126135 A1
(43) Pub. Date: May 21, 2009

(54) Scratch off tool for lottery tickets

(76) Inventors: Alton Gilmore, Medford, NY (US); Kelley Gilmore, Medford, NY (US)

Correspondence Address: Hoffman, Wasson & Gitler, P.C., Suite 522, 2461 South Clark Street, Arlington, VA, 22202, US

(21) Appl. No.: 11/984,644

(22) Filed: Nov. 20, 2007

(51) Int. Cl. A63F 3/06; B26B 27/00; B44D 3/16

(52) U.S. Cl. 15/105; 15/236.01; 30/123; 30/169

(57) ABSTRACT

A scratch off tool for removing coverings from a lottery game piece has a body with a blade extending from the body. The blade is used to remove the scratch off covering from the game piece. The body is provided with an aperture to allow the tool to be attached to a key chain. Also, a magnifying glass is embedded within the body for use in reading the lottery game piece.

### BACKGROUND OF THE INVENTION

Lotteries are a great source of revenue for state governments. In one version of a lottery, numbers are chosen and if the buyer of a ticket has correctly matched the chosen numbers, prizes are awarded, including grand prizes of several million dollars.

Another version of a lottery is a scratch off game having a card with certain areas covered with a metallic or latex covering. The buyer removes the covering to reveal whether the ticket is a winning ticket. There are a wide variety of such scratch off games. In some games, the buyer must choose one of several scratch off errors in which to remove. Removal of more than the designated number of scratch off coverings on the game piece voids any winnings.

### SUMMARY OF THE INVENTION

A scratch off tool for removing coverings from a lottery game piece has a body with a blade extending from the body. The blade is used to remove the scratch off covering from the game piece. The body is provided with an aperture to allow the tool to be attached to a key chain. Also, a magnifying glass is embedded within the body for use in reading the lottery game piece.

### BRIEF DESCRIPTION OF THE DRAWINGS

FIG. 1 depicts the scratch off tool; and

FIGS. 2-5 show alternative embodiments of the tool.

### DETAILED DESCRIPTION OF THE INVENTION

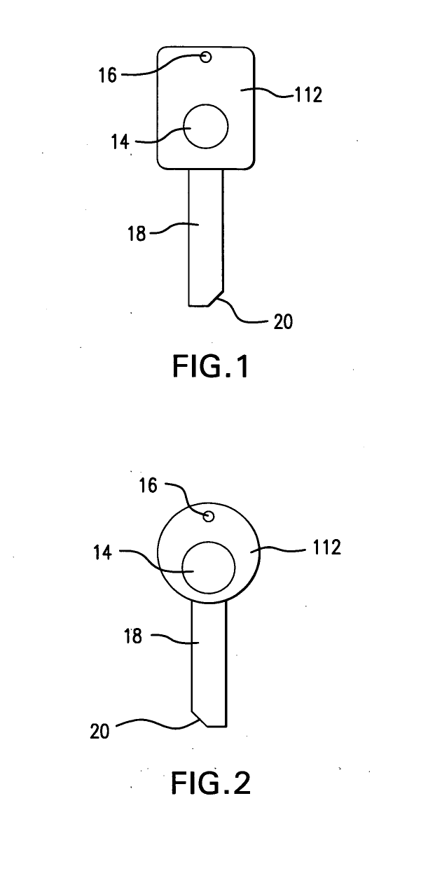

As seen in FIG. 1, the tool has a body 12 formed of any suitable material, such as plastic. Extending from the body 12 is a blade 18 which is also made of any suitable materials such as plastic or metal. The blade may be made of the same material as the body 12 to ease the manufacture of the device but does not necessarily have to be so. The blade has smooth edges and sides with a bevel 20 at the end. The bevel provides a surface which will lie flat against the lottery card when the tool is at an angle to the card, increasing the comfort and ease in using the device.

A magnifying glass 14 embedded in the body 12 facilitates in reading the card after the scratch off material has been removed. The magnifying glass may be made of any suitable material such as plastic or glass. An aperture 16 proximate the top edge and centered between the left and right sides allows for the tool to be attached to a device such as a key chain. The tool has overall dimensions of approximately 2″ long by 1″ wide allowing the tool to be attached to a key chain and easily carried in a pocket or a purse.

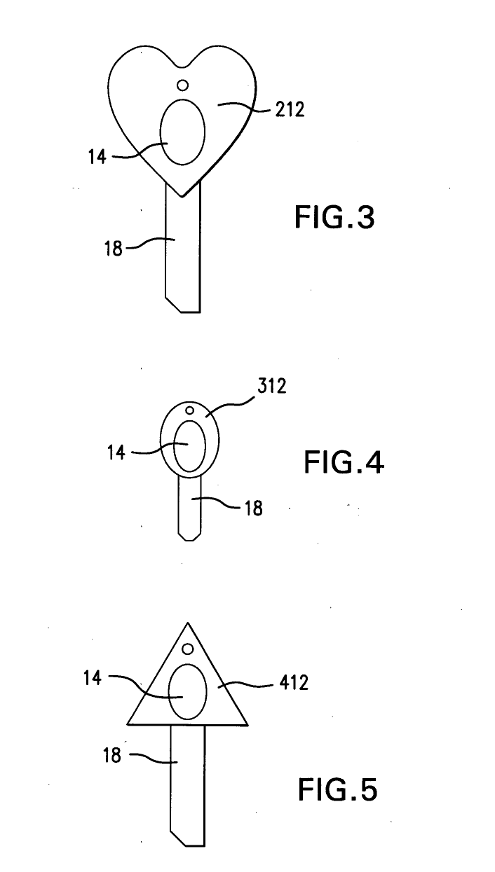

FIGS. 2-5 show different embodiments of the tool. In FIG. 2, the body is circular. In FIG. 3, the body is heart shaped and the magnifying glass 14 is oval. In FIG. 4, both the body 312 and magnifying glass 14 are oval and the blade 18 is provided with two beveled edges. FIG. 5 shows a body 412 which is triangular yet still accommodates a magnifying glass 14 and an aperture above the magnifying glass.

While the invention has been described with reference to preferred embodiments, various modifications would be apparent to one of ordinary skill in the art without departing from the scope of the invention.

1. A scratch off tool consisting of:
a body having a top surface and a bottom surface,
a magnifying glass embedded within said body,
a single blade extending from the body, the blade having a top edge, a bottom edge and an end edge opposite the body, the top and bottom edges being parallel and smooth, and
a bevel on the end edge;
wherein a lottery ticket is read through said magnifying glass when the lottery ticket is placed against said bottom surface of said body.

2. (canceled)

3. The tool of claim 1, wherein the blade is made of plastic.

4. The tool of claim 1, further comprising
an aperture in the body for allowing attachment of the tool to a key chain.

5. The tool of claim 1, wherein the body is rectangular, triangular, round, oval or heart shaped.

6. The tool of claim 1, wherein
the body and blade are made of the same material.

7. The tool of claim 1, wherein the bevel extends between the end and bottom edge.

8. A scratch off tool consisting of:
a body having a magnifying glass embedded therein;
an elongated single blade extending from the body, the blade having a top edge, a bottom edge and an end edge opposite the body, the top and bottom edges being parallel and smooth, and
a single bevel on said end edge.
